(19) United States
(12) Patent Application Publication
(10) Pub. No.: US 2012/0265381 A1
(43) Pub. Date: Oct. 18, 2012

(54) Electric Vehicle Having Motor And Generator And Driving Method Thereof

(76) Inventor: Oak Jae Lee, Gwangyang-si (KR)

(21) Appl. No.: 12/936,641

(22) PCT Filed: Jul. 7, 2009
(86) PCT No.: PCT/KR2009/003717

§ 371 Date: Oct. 6, 2010

(51) Int. Cl. B60L 15/00

(52) U.S. Cl. 701/22; 180/65.285; 903/902

(57) ABSTRACT

The present invention relates to an electric vehicle having a motor generator and a driving method therefor, and more particularly, to an electric vehicle having a motor generator, which can control the operation ratio of a motor and a generator, and a driving method therefor. In accordance with one aspect of the present invention, an electric vehicle is provided, which comprises: a plurality of rotating means; a motor generator including a rotor having a plurality of magnets and a stator having a plurality of induction coils and a plurality of generating coils, wherein the motor generator is disposed with respect to at least one of the plurality of rotating means; a charging unit for charging electric energy produced by the motor generator; a battery unit for storing the electric energy received from the charging unit; an accelerator for controlling the acceleration state of the electric vehicle under control of a driver of the electric vehicle; and control unit for operating at least some of the plurality of induction coils in the motor generator as generating coils, depending on the acceleration state and/or the speed of the electric vehicle, or for operating at least some of the plurality of generating coils in the motor generator as induction coils, depending on the acceleration state and/or the speed of the electric vehicle.

### TECHNICAL FIELD

The present invention relates to an electric vehicle having a motor generator and a driving method therefor, and more particularly, to an electric vehicle having a motor generator, which can control the operation ratio of a motor and a generator, and a driving method therefor.

### BACKGROUND ART

As energy problems caused by the depletion of fossil fuels such as oil and environmental problems caused by global warming has become an issue of global concern, next-generation vehicles capable of replacing vehicles with existing engines (e.g., a gasoline engine, a diesel engine, etc.) are being developed in many countries around the world. A typical example of such vehicles includes an electric automobile using a secondary battery. Such an electric automobile employs a method of driving a vehicle with electric energy charged to the secondary battery, rather than with combustion heat energy generated by the engine.

However, the electric automobile using the secondary battery alone has difficulty in commercialization because of low charging efficiency, limited lifetime of the second battery, or the like. To overcome this, there was a suggestion of a hybrid electric automobile that has two different types of power sources, i.e., uses both an engine and a secondary battery.

The hybrid electric automobile may be classified into a serial hybrid system and a parallel hybrid system depending on its operating scheme.

First, the serial hybrid system employs a method of basically driving the electric automobile with the electric energy of the secondary battery, and, if required, driving the electric automobile using the combustion heat energy of the engine. In the latter case, the combustion heat energy of the engine can be converted into mechanical energy, and the mechanical energy can be converted back into electric energy and charged to the secondary battery.

On the contrary, the parallel hybrid system adopts a method of driving the electric automobile with the electric energy of the secondary battery, and driving the electric automobile with the combustion heat energy of the engine as well. In accordance with this parallel hybrid system, the electric automobile may be driven using both electric energy and combustion heat energy according to the traveling conditions.

However, both of the above two types of hybrid electric automobiles do not have sufficiently high energy use efficiency. In a typical example, even with self-generation using the wheels rotating with traveling of the hybrid electric automobile, there has been some problem that the efficiency of the self-generation is significantly reduced depending on various complicated traveling conditions of the automobile and the running state of the automobile, except when the automobile is running at an almost constant speed.

### DISCLOSURE

### Technical Problem

It is, therefore, an object of the present invention to solve all the problems of the prior arts described above.

Another object of the present invention is to achieve optimized motor and generator operations depending on the running state of an electric vehicle.

Still another object of the present invention is to perform power generation in conjunction with the braking of the electric vehicle.

Still another object of the present invention is to provide an electric vehicle having various power generation sources.

### Technical Solution

Representative configurations of the present invention to accomplish the objects discussed above are as follows:

In accordance with one aspect of the present invention, an electric vehicle is provided, which comprises: a plurality of rotating means; a motor generator including a rotor having a plurality of magnets and a stator having a plurality of induction coils and a plurality of generating coils, wherein the motor generator is disposed with respect to at least one of the plurality of rotating means; a charging unit for charging electric energy produced by the motor generator; a battery unit for storing the electric energy received from the charging unit; an accelerator for controlling the acceleration state of the electric vehicle under control of a driver of the electric vehicle; and a control unit for operating at least some of the plurality of induction coils in the motor generator as generating coils, depending on the acceleration state and/or the speed of the electric vehicle, or for operating at least some of the plurality of generating coils in the motor generator as induction coils, depending on the acceleration state and/or the speed of the electric vehicle.

In accordance with another aspect of the present invention, a method of driving an electric vehicle is provided, which comprises: performing switching such that all of a plurality of coils included in a stator of a motor generator are substantially operated as induction coils upon a start of the electric vehicle; and performing switching such that all of the plurality of coils are substantially operated as generating coils in case the electric vehicle is not accelerated.

### Advantageous Effects

In accordance with the present invention, optimized motor and generator operations can be achieved depending on the running state of en electric vehicle, thereby greatly improving the traveling performance or power generation efficiency of the electric vehicle.

In accordance with the present invention, power generation can be performed in conjunction with the braking of the electric vehicle, thereby enabling efficient energy regeneration.

In accordance with the present invention, an electric vehicle having various, environment-friendly power generation sources is provided.

### DESCRIPTION OF DRAWINGS

The above and other objects and features of the present invention will become apparent from the following description of the preferred embodiments, given in conjunction with the accompanying drawings, in which:

FIG. 1 is a view showing the configuration of an electric vehicle having a motor generator i00 in accordance with Embodiment 1 of the present invention;

FIG. 2 is a cross-sectional view illustrating part of the electric vehicle having the motor generator 100 in accordance with Embodiment 1 of the present invention.

FIG. 3 is a view for explaining the switching of a coil unit in accordance with one embodiment of the present invention;

FIG. 4 is a view showing the configuration of an electric vehicle having a braking generator 700 in accordance with Embodiment 2 of the present invention;

FIGS. 5 and 6 are cross-sectional views illustrating part of the electric vehicle having the braking generator 700 in accordance with Embodiment 2 of the present invention;

FIG. 7 is a view showing the configuration of an electric vehicle in accordance with Embodiment 3 of the present invention; and

FIGS. 8 and 9 are views showing an example of an electric vehicle in accordance with the present invention.

### BEST MODE FOR THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different from one another, are not necessarily mutually exclusive. For example, a particular feature, structure, and characteristic described herein in connection with one embodiment may be implemented within other embodiments without departing from the spirit and scope of the present invention. Also, it is to be understood that the positions or arrangements of individual elements in the disclosed embodiments may be changed without separating the spirit and scope of the present invention. The following detailed description is, therefore, not to be taken in a limiting sense, and the scope of the invention is defined only by the appended claims that should be appropriately interpreted along with the full range of equivalents to which the claims are entitled. In the drawings, like reference numerals identify identical or like elements or functions through the several views.

Hereinafter, preferred embodiments of the present invention will be described in detail with reference to the accompanying drawings so that those skilled in the art to which the invention pertains can easily carry out the present invention.

### Embodiment 1

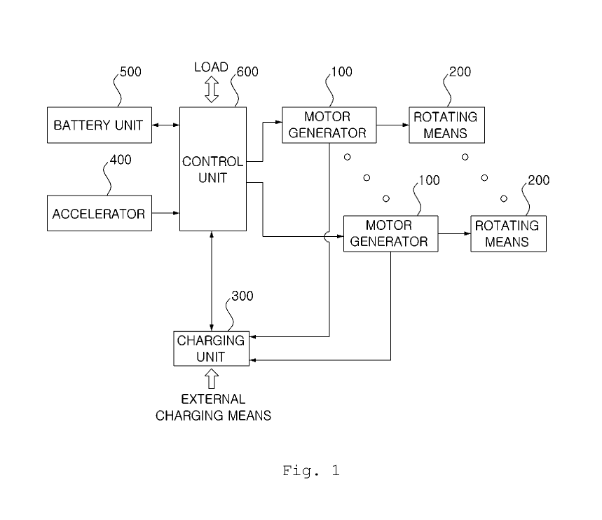

FIG. 1 is a block diagram showing the configuration of an electric vehicle having a motor generator 100 in accordance with Embodiment 1 of the present invention.

Referring to FIG. 1, an electric vehicle in accordance with one embodiment of the present invention includes a motor generator 100, rotating means 200, a charging unit 300, an accelerator 400, a battery unit 500, and a control unit 600.

First, the motor generator 100 in accordance with one embodiment of the present invention may be located corresponding to at least one of a plurality of rotating means 200 of the electric vehicle, preferably, corresponding to each individual rotating means 200. The motor generator 100 may perform the function of converting electric energy into rotational kinetic energy to rotate the rotating means 200, or converting the rotational kinetic energy of the rotating means 200 into electric energy.

The motor generator 100 may include a rotor rotating in concert with the rotating means 200 and having a magnet unit including a plurality of magnets arranged thereon, and a stator located insulatively from the rotor by a predetermined gap and including a coil unit having a plurality of induction coils and a plurality of generating coils arranged thereon in an alternating fashion.

That is, in the motor generator 100, when the rotating means 200 rotates, the rotor including the plurality of magnets rotates as well. As a result, simultaneously with traveling of the electric vehicle, each of the plurality of induction coils and the plurality of generating coils of the stator undergoes a change in electric field.

Therefore, in accordance with one embodiment of the present invention, a torque for rotating the rotor of the motor generator 100 may be generated by current flowing through each of the induction coils, and induced current caused by induced electromotive force flows through each of the generating coils, thus enabling the motor generator 100 to obtain alternating current that periodically changes in intensity and direction. This will be described later.

Next, the rotating means 200 in accordance with one embodiment of the present invention can perform the function of running the electric vehicle by the torque from the motor generator 100. The rotating means 200 may be wheels which are generally used in vehicles. As discussed above, the rotating means 200 may be provided in plural in one electric vehicle. Particularly, the rotating means 200 in accordance with one embodiment of the present invention can work with the rotor of the motor generator 100, which will be described later.

Further, the charging unit 300 in accordance with one embodiment of the present invention can perform the function of collecting electric energy generated by the motor generator 100 and charging it to the battery unit 500.

Although not shown, the charging unit 300 may include a transformer, a rectification circuit, a smoothing circuit, etc. An alternating voltage supplied from the motor generator 100 can be transformed by the transformer, rectified by the rectification circuit, and then the ripple contained in the rectified voltage output from the rectification circuit can be eliminated by the smoothing circuit.

In this configuration, the rectification circuit may be a full-wave rectification circuit using a bridge circuit, and the smoothing circuit may include a resistive element and a capacitive element.

Accordingly, the charging unit 300 in accordance with one embodiment of the present invention can convert an alternating voltage generated by the motor generator 100 into a stable direct voltage to charge the battery unit 500.

Further, the charging unit 300 in accordance with one embodiment of the present invention may be adapted to be connected to external charging means (e.g., a plug-in charger) such that a user can conveniently perform charging at home, an office, a parking lot, or the like. With this, charging is possible even when the battery unit 500 is fully discharged.

Next, the accelerator 400 in accordance with one embodiment of the present invention, which interworks with the accelerator pedal of the electric vehicle, may vary in acceleration state depending on how the driver of the electric vehicle controls the acceleration pedal, and the traveling speed of the electric vehicle and the operation ratio of the motor and generator of the motor generator 100 may be controlled based on the acceleration state.

Next, the battery unit 500 in accordance with one embodiment of the present invention is electricity storage means for charging electric energy. Any chargeable/dischargeable electricity storage means can be used as the battery unit 500 without limitation. One example of the electricity storage means includes secondary batteries such as a lead acid battery, a nickel cadmium (NiCd) battery, a nickel metal hydride (NIMH) battery, a lithium ion (Li-ion) battery, and a lithium ion polymer (Li-ion polymer) battery. Optionally, the battery unit 500 may include a plurality of divided batteries (not shown), rather than a single battery. The plurality of divided batteries may be electrically connected to each other, or independent from each other.

Preferably, a plurality of motor generators 100 may be respectively provided with corresponding battery units 500, and these battery units 500 may be distinguished from a battery chargeable by external charging means.

Finally, the control unit 600 in accordance with one embodiment of the present invention can perform the function of controlling the motor generator 100, the rotating means 200, the charging unit 300, the accelerator 400, and the battery unit 500. The control unit 600 can control a control signal exchanged or flowing between the above-mentioned components and other not-shown components (e.g., loads) within the electric vehicle to allow each of the components to perform its intrinsic function.

Particularly, the control unit 600 in accordance with one embodiment of the present invention can control the ratio of the induction coils and generating coils of the stator of the motor generator 100. Thus, motor efficiency and generator efficiency can be improved by optimizing the operation ratio of the motor and generator of the motor generator 100.

Hereinafter, the internal configuration of the motor generator 100 in accordance with one embodiment of the present invention and the functions of each of the components will be described in detail.

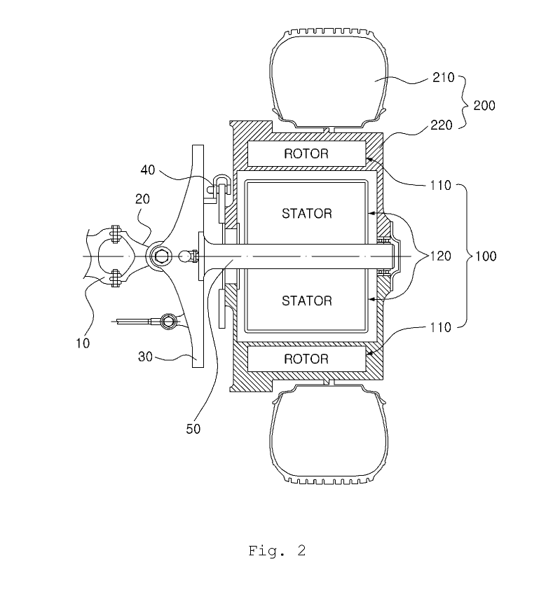

FIG. 2 is a cross-sectional view illustrating part of an electric vehicle having the motor generator 100 in accordance with Embodiment 1 of the present invention.

Referring to FIG. 2, the motor generator 100 in accordance with one embodiment of the present invention may include a rotor 110 and a stator 120.

First, the rotor 110 includes a magnet unit including a plurality of magnets rotating in concert with the rotating means 200. The magnet unit may have permanent magnets radially placed on a first disc (not shown). The number of poles of the rotor 110 may be determined variously depending on the number of phases of the stator 120.

In accordance with one embodiment of the present invention, the rotor 110 may be housed in a rotating frame 220 of the rotating means 200 without having to provide a separate first disc in the motor generator 100 in order to achieve a more simplified configuration. Particularly, the first disc or the rotating frame 220 may have a circular structure and have an opening at the center in which a stationary shaft 50 is installed. The stationary shaft 50 may be connected to a structure such as a body 10, rod arm 20, or support 30 of the electric vehicle and function as the central axis of rotation for traveling of the vehicle.

Meanwhile, the stator 120 is located insulatively from the rotor 110 by a predetermined gap, and includes a coil unit having a plurality of induction coils and a plurality of generating coils arranged thereon in an alternating fashion. The coil unit may have induction coils, which rotate the rotor 110 when current flows, and generating coils, through which current flows in response to induced electromotive force generated by the stator 110, both of which are radially provided on a second disc (not shown) in an alternating fashion. Besides, the configurations of the rotor 110 and the stator 120 can be freely changed as required by those skilled in the art as long as the above-described functions of the rotor 110 and the stator 120 are realized.

Regarding the above-described motor generator 100 in accordance with one embodiment of the present invention, further reference can be made to Korean Patent No. 10-0815429, entitled “Constant power brushless DC motor,” which was filed and registered by the applicant of the present application.

In accordance with one embodiment of the present invention, the operation ratio of the motor and generator of the motor generator 100 can be controlled by controlling the switching of the coil unit consisting of a plurality of coils (induction coils and/or generating coils) included in the stator 120 of the motor generator 100. The switching of the coil unit can be performed by the controller 600.

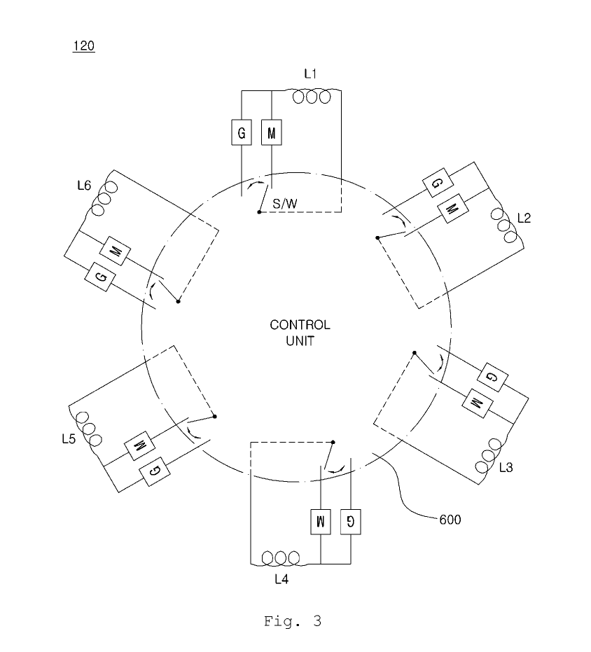

FIG. 3 is a view for explaining the switching of the coil unit in accordance with one embodiment of the present invention.

Referring to FIG. 3, the stator 120 is radially arranged on the second disc (not shown). The switching of the coils L1 to L6 (basically, L1, L3, and L5 may be induction coils and L2, L4, and L6 may be generating coils) included in the stator 120 can be controlled by the control unit 600 as in the following Table 1 (of course, the running states indicated in Table 1 are assumed for illustrative purposes to describe the present invention, and other various running states may be assumed). That is, the induction coils and/or the generating coils may function as generating coils and/or induction coils depending on the running state of the electric vehicle.

TABLE 1

| Running | First | Second | Third | |
|---|---|---|---|---|
| state | state | state | state | Fourth state |
| Speed | 0 (stop) | Low | High | Highest |
| Acceleration | Highest | High | Low | 0 (not |
| | | | | accelerated) |
| Switching | All of | All except | All except | All of L1 to |
| control | L1 to L6 | some of L2, | some of | L6 function |
| | function | L4, and L6 | L1, L3, | as |
| | as | function as | and L5 | generating |
| | induction | induction | function | coils |
| | coils | coils | as | |
| | | | generating | |
| | | | coils | |

Referring to the above Table 1, it can be seen that, at a starting moment when the electric vehicle requires high power, all of the coils L1 to L6 are switched so as to be connected to the motor; when the electric vehicle requires relatively low power, some of the induction coils are switched so as to be connected to the generator in place of the motor; and when the electric vehicle does not require additional acceleration, all of the coils L1 to L6 are switched so as to be connected to the generator. Such a switching operation by the control unit 600 contributes to maximize the motor efficiency and generator efficiency of the motor generator 100.

### Embodiment 2

An electric vehicle in accordance with Embodiment 2 of the present invention has the same configuration as the electric vehicle of Embodiment 1 described with reference to FIG. 1 except that it additionally has a braking generator. Thus, in the description of Embodiment 2 of the present invention, a detailed description of components other than the braking generator will be omitted here.

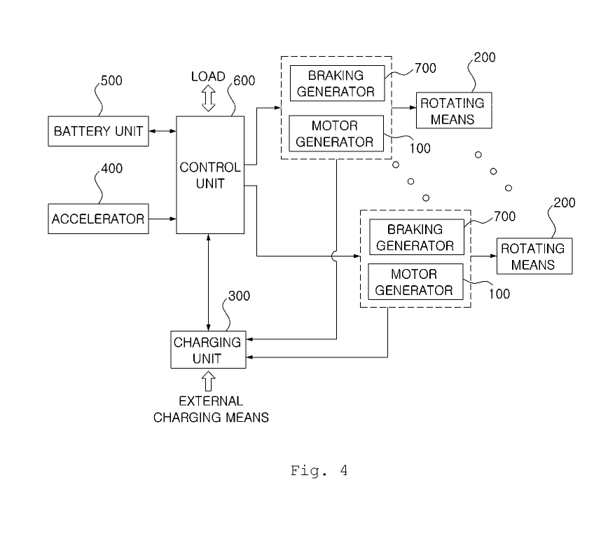

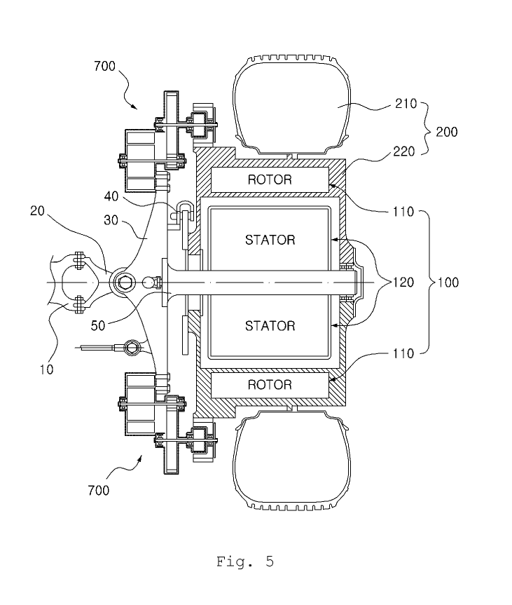

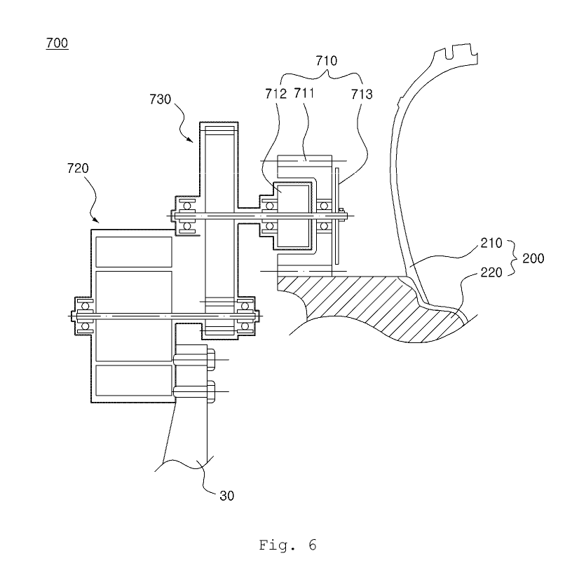

FIG. 4 is a block diagram showing the configuration of an electric vehicle having a braking generator 700 in accordance with Embodiment 2 of the present invention. And, FIGS. 5 and 6 are cross-sectional views illustrating part of the electric vehicle having the braking generator 700 in accordance with Embodiment 2 of the present invention.

First, referring to FIG. 4, the electric vehicle in accordance with one embodiment of the present invention includes a motor generator 100, rotating means 200, a charging unit 300, an accelerator 400, a battery unit 500, a control unit 600, and a braking generator 700. Here, the braking generator 700 in accordance with one embodiment of the present invention is a device capable of performing power generation in conjunction with power generation type of braking of the electric vehicle.

Next, referring to FIGS. 5 and 6, the braking generator 700 may include an attachment device 710, a generator 720, and a connecting gear 730, in which the attachment device 710 may consist of an idle gear 711, an electromagnet 712, and an attachment plate 713.

First, the idle gear 711, which is a component that receives rotation from the rotating means 200, passively rotates in accordance with the rotation of the rotating means 200.

Meanwhile, the electromagnet 712 is a component that is magnetized when power is supplied under the control of the driver, and attaches the idle gear 711 and the attachment plate 713 together to transmit the rotation of the idle gear 711 to the connecting gear 730. Eventually, by such an operation of the electromagnet 712, the rotation of the rotating means 200 is sequentially transmitted to the idle gear 711, the connecting gear 730, and a gear connected to a shaft for rotating the magnets of the generator 720, thereby enabling the generator 720 to perform power generation. In line with the above, the rotation of the rotating means 200 is inhibited due to the power generation load of the generator 720, so the vehicle may be braked. In this case, the power generation load has a positive correlation with the amount of the power generated by the generator 720. Preferably, the diameter ratio of the rotating means 200 with respect to the idle gear 711 or the diameter ratio of the connecting gear 730 with respect to the gear connected to the rotating shaft of the generator 720 is large.

Further, the attachment plate 713 is preferably made of a high abrasion resistant material that may exhibit magnetism by the electromagnet 712, and may reduce and resist the rotation of the rotating means 200 when attached to the idle gear 711.

Next, the generator 720 is a device capable of converting mechanical energy caused by the rotation of the rotating means 200 into electric energy, a detailed description of which will be omitted herein because well-known generator technologies can be used without restrictions.

Further, the connecting gear 730 in accordance with one embodiment of the present invention is located between the attachment device 710 and the generator 720, and can perform the function of transmitting rotation from the attachment device 710 to the generator 720 at a high RPM ratio via multiple gears and a rotating shaft.

Accordingly, one or more braking generators 700 having the above configuration may be installed for each of the wheels, which are the rotating means 200 of the electric vehicle, and perform both braking and power generation.

When higher braking force is required, a braking device 40, such as a conventional disc brake or drum brake, may be further used to perform braking. In addition, by using both of the conventional braking device 40 and the braking generator 700 together, the abrasion of lining (such as a brake shoe) may be minimized and pollution factors may be reduced.

### Embodiment 3

An electric vehicle in accordance with Embodiment 3 of the present invention has the same configuration as the electric vehicle of Embodiment 2 referring to FIGS. 4, 5 and 6, except that it additionally has a power generation part (i.e., a solar generator, a wind generator, or a fuel generator). Thus, in the following description, a detailed description of other components will be omitted here to avoid redundant explanation.

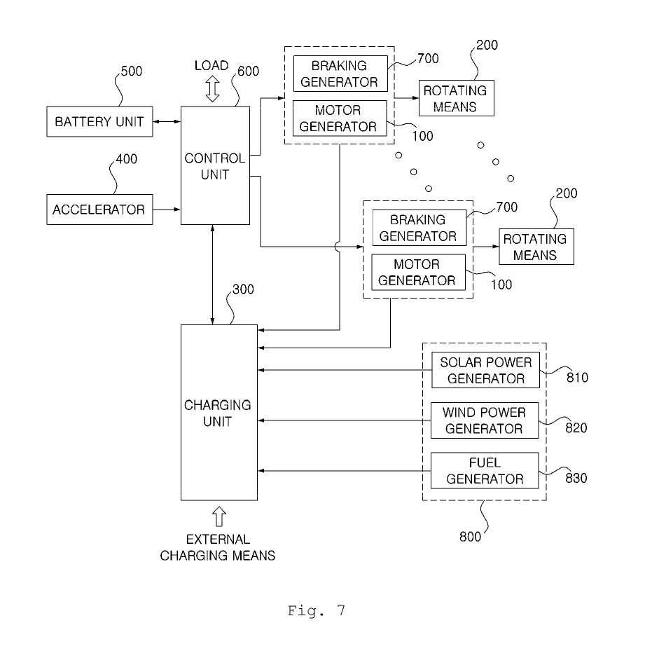

FIG. 7 is a block diagram showing the configuration of an electric vehicle in accordance with Embodiment 3 of the present invention.

Referring to FIG. 7, an electric vehicle in accordance with one embodiment of the present invention includes a motor generator 100, rotating means 200, a charging unit 300, an accelerator 400, a battery unit 500, a control unit 600, a braking generator 700, and a power generation part 800.

The power generation part 800 in accordance with one embodiment of the present invention is a power generation source for additionally supplying electric energy irrespective of the battery 500.

The power generation part 800 may include at least one of a solar generator 810, a wind generator 820, and a fuel generator 830.

First, the solar generator 810 is a device that receives light from an external light source such as the sun and generates electric energy, and may include a solar cell battery.

Further, the power generator 820 is a device that converts wind energy generated during traveling of the electric vehicle or wind energy obtained from natural wind into electric energy.

Meanwhile, the fuel generator 830, which is a device that performs power generation using a variety of conventional combustible fossil fuels, burns a small amount of fossil fuel and converts resulting combustion heat energy into electric energy. The principle of the fuel generator 830 is identical to that employed in a lamp which is lighted by burning oil.

Since the specific implementations of the variety of generators 810, 820, and 830 that can be included in the above-described power generation part 800 fall within the scope obvious to those skilled in the art, a detailed description thereof will be omitted here.

As such, the electric energy produced by the power generation part 800 in accordance with Embodiment 3 of the present invention may be delivered to the charging unit 300 of the electric vehicle, thus contributing to the charging of the electric vehicle.

### INDUSTRIAL APPLICABILITY

### Application Example of the Invention

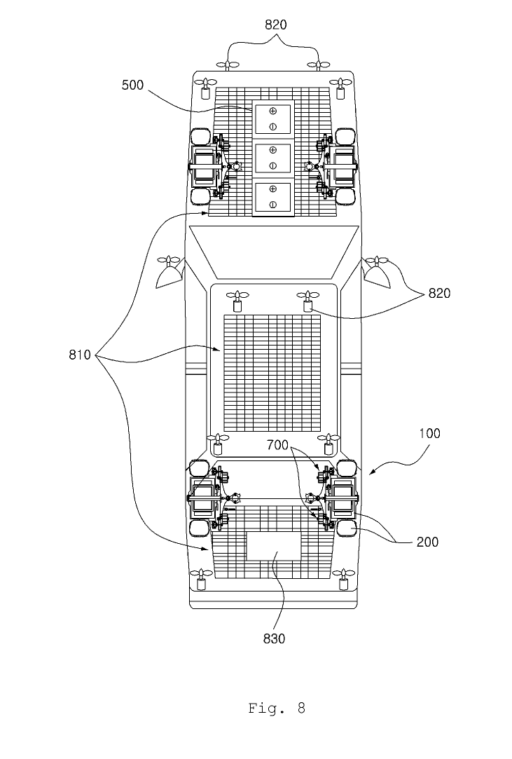

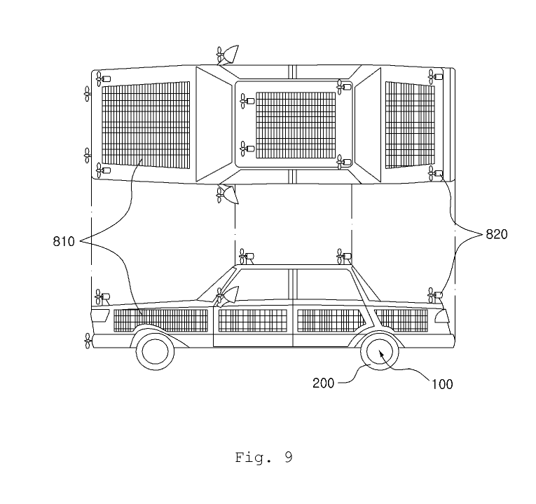

In this section, an application example of the specific implementation of the electric vehicle in accordance with various embodiments of the present invention will be described with reference to FIGS. 8 and 9.

FIGS. 8 and 9 are views showing an example of an electric vehicle in accordance with the present invention.

Referring to FIGS. 8 and 9, the motor generator 100 and the braking generator 700 of the present invention can be included in an electric vehicle for application. At this point, the solar generator 810 may be disposed in a matrix form on top of the electric vehicle, and the wind generator 820 may be disposed, as shown in the drawings, at a position in the electric vehicle where wind power may be easily obtained.

In addition, the fuel generator 830 may be further provided within the electric vehicle so as to supply immediately needed electric energy using a small amount of fuel.

Although the above description has been made on the assumption that the electric vehicle in accordance with the present invention is an electric vehicle with four wheels, it will be obvious that the technical spirit of the present invention may be also applied to a two-wheel vehicle, such as a motorbike, or a vehicle having more than four wheels, depending on design changes made by those skilled in the art.

What is claimed is:

1. An electric vehicle comprising:
a plurality of rotating means;
a motor generator including a rotor having a plurality of magnets and a stator having a plurality of induction coils and a plurality of generating coils, wherein the motor generator is disposed with respect to at least one of the plurality of rotating means;
a charging unit for charging electric energy produced by the motor generator;
a battery unit for storing the electric energy received from the charging unit;
an accelerator for controlling the acceleration state of the electric vehicle under control of a driver of the electric vehicle; and
a control unit for operating at least some of the plurality of induction coils in the motor generator as generating coils, depending on the acceleration state and/or the speed of the electric vehicle, or for operating at least some of the plurality of generating coils in the motor generator as induction coils, depending on the acceleration state and/or the speed of the electric vehicle.

2. The electric vehicle of claim 1, wherein at least some of the plurality of induction coils in the motor generator is operated as generating coils in case the electric vehicle maintains a certain speed, not being accelerated.

3. The electric vehicle of claim 1, wherein at least some of the plurality of generating coils in the motor generator is operated as induction coils in case the electric vehicle is accelerated.

4. The electric vehicle of claim 1, further comprising a power generation part including at least one of a solar power generator, a wind power generator and a fuel generator,
wherein the charging unit is configured to further charge electric energy produced by the power generation part.

5. The electric vehicle of claim 1, further comprising a braking generator,
wherein the braking generator includes:
an attachment device configured to rotate in contact with at least one of the plurality of rotating means and reduce the rotation of the corresponding rotating means as power is supplied;
a generator for converting rotational kinetic energy from the attachment device into electric energy; and
a connecting gear, located between the attachment device and the generator, for transmitting rotation.

6. The electric vehicle of claim 5, wherein the attachment device includes:
an idle gear configured to manually rotate following the rotation of the corresponding rotating means;
an electromagnet magnetized by the power supply; and
an attachment plate attached to the idle gear when the electromagnet is magnetized.

7. A method of driving an electric vehicle, comprising:
performing switching such that all of a plurality of coils included in a stator of a motor generator are substantially operated as induction coils upon a start of the electric vehicle; and
performing switching such that all of the plurality of coils are substantially operated as generating coils in case the electric vehicle is not accelerated.
